(19) United States
(12) Patent Application Publication
(10) Pub. No.: US 2025/0058605 A1
(43) Pub. Date: Feb. 20, 2025

(54) MANIFOLD FLUID MODULE

(71) Applicant: Hanon Systems, Daejeon (KR)

(72) Inventors: Sang Gu WOO, Daejeon (KR); Moo Joong KIM, Daejeon (KR); Kyung Tae NOH, Daejeon (KR); Hae Jun LEE, Daejeon (KR)

(21) Appl. No.: 18/728,489

(22) PCT Filed: Aug. 2, 2023
(86) PCT No.: PCT/KR2023/011288

§ 371 Date: Jul. 12, 2024

(30) Foreign Application Priority Data
Aug. 2, 2022 (KR) 10-2022-0095896

(51) Int. Cl. B60H 1/32

(52) U.S. Cl. CPC B60H 1/3223; B60H 1/32281; B60H 1/3229

(57) ABSTRACT

A manifold fluid module according to the present invention includes a manifold plate having a fluid flow path formed therein, a compressor coupled to the manifold plate, and a first heat exchanger which is coupled to the manifold plate and connected such that a first fluid flowing out from the compressor is directly introduced thereinto, and heat-exchanges the first fluid and a second fluid, wherein the compressor is coupled to one surface of the manifold plate, and the first heat exchanger is coupled to the other surface of the manifold plate, and the compressor has a first fluid inlet port and a first fluid outlet port, and one of the first fluid inlet port or the first fluid outlet port of the compressor may be directly connected to and communicate with any one of the first inlet port or the first fluid outlet port of the first heat exchanger.

### TECHNICAL FIELD

The present invention relates to a manifold fluid module, and more specifically, to a manifold fluid module in which components of heat exchangers and valves are modularized into a single unit.

### BACKGROUND ART

Under the trend of environmentally friendly industrial development and the development of energy sources to replace fossil fuels, the most prominent fields in the recent automobile industry are electric vehicles and hybrid vehicles. Electric vehicles and hybrid vehicles are equipped with batteries that provide driving force, and these batteries are used not only for driving but also for heating and cooling.

In vehicles that provide the driving force using batteries, the fact that a battery is used as a heat source during heating and cooling means that the driving range is reduced by as much as the used amount. To overcome this issue, the conventional method of applying a heat pump system, which has been widely used in household heating and cooling devices, to vehicles has been proposed.

For reference, a heat pump absorbs low-temperature heat and transfers the absorbed heat into high-temperature heat. For example, the heat pump operates on a cycle in which liquid fluid is evaporated by an evaporator and absorbs heat from surroundings to become gas and then the gas is liquefied by a condenser while releasing heat to the surroundings. When this is applied to electric or hybrid vehicles, it has the advantage of securing a heat source that is lacking in conventional air conditioning systems.

Currently, in the modular configuration of heat pump systems for electric vehicles as a partial modularization method, key components (such as valves, accumulators, chillers, condensers, internal heat exchangers, and sensors) are connected by piping. To connect this piping, fittings and connectors should be separately provided, and appropriate gaps between the components should occur for connection of the components. As a result, there are disadvantages in packaging, costs, and workability. Furthermore, in the process of modularizing the manifold, there is a problem of reduced heat pump performance due to thermal interference between high-temperature fluid and low-temperature fluid.

### DISCLOSURE

### Technical Problem

An embodiment of the present invention provides a manifold fluid module which can increase workability and reduce weight and costs by using a manifold plate which performs the functions of piping, fittings, and a housing.

Also, an embodiment of the present invention provides a manifold fluid module which can minimize thermal interference between refrigerants and increase heat pump performance through the arrangement of fluid flow paths of the manifold plate and the heat exchangers.

### Technical Solution

A manifold fluid module according to an embodiment of the present invention may include a manifold plate in which a fluid flow path is formed, a compressor coupled to the manifold plate, and a first heat exchanger which is coupled to the manifold plate, is connected to directly receive a first fluid flowing out of the compressor, and exchanges heat between the first fluid and a second fluid, wherein the compressor is coupled to one surface of the manifold plate, the first heat exchanger is coupled to the other surface of the manifold plate and has a first fluid inlet port and a first fluid outlet port, the first heat exchanger has a first fluid inlet port and a first fluid outlet port, and any one of the first fluid inlet port or the first fluid outlet port of the compressor is directly connected to and communicates with any one of the first fluid inlet port or the first fluid outlet port of the first heat exchanger.

The first fluid outlet port of the compressor may be directly connected to and communicate with the first fluid inlet port of the first heat exchanger.

The first fluid inlet port of the compressor may be coupled to one surface of the manifold plate, and the first fluid outlet port of the first heat exchanger may be coupled to the other surface of the manifold plate.

The manifold fluid module may further include a second heat exchanger coupled to the manifold plate and exchanging heat between the first fluid, which flows out of the first heat exchanger, and the second fluid.

The exchanging of the heat is performed by allowing the first fluid to flow into an upper portion and move to a lower portion in the first heat exchanger and allowing the first fluid to flow into a lower portion and move to an upper portion in the second heat exchanger.

The first fluid inlet port and the first fluid outlet port for inflow and outflow of the first fluid may be provided on one surface of each of the first heat exchanger and the second heat exchanger, and the second fluid inlet port and the second fluid outlet port for inflow and outflow of the second fluid may be provided on the other surface of each of the first heat exchanger and the second heat exchanger.

The first fluid inlet port and the first outlet port may be directly connected to the fluid flow path of the manifold plate, and the second fluid inlet port and the second fluid outlet port may be provided outside the first heat exchanger and the second heat exchanger.

The first fluid inlet ports may be disposed on upper portions of the first heat exchanger and the second heat exchanger, and the first fluid outlet ports may be disposed on lower portions of the first heat exchanger and the second heat exchanger.

The second fluid inlet ports may be disposed on lower portions of the first heat exchanger and the second heat exchanger, and the second fluid outlet ports may be disposed on upper portions of the first heat exchanger and the second heat exchanger.

Fastening parts for coupling with the manifold plate may be formed to extend from an upper portion and a lower portion of the second heat exchanger.

At least one opening may be formed in the manifold plate to avoid thermal interference between a high temperature first fluid and a low temperature first fluid.

The opening may be formed adjacent to a flow path of the first fluid flowing into the compressor.

A third heat exchanger and an accumulator may be coupled to the manifold plate, wherein the third heat exchanger evaporates the first fluid, which flows out of the first heat exchanger, by exchanging heat between the first fluid and the second fluid, and the accumulator divides the first fluid, which passes through the second heat exchanger, into a gaseous fluid and a liquid fluid.

The first heat exchanger may be disposed on one side of the manifold plate, the second heat exchanger and the third heat exchanger may be disposed on the other side, and the accumulator may be disposed between the first heat exchanger and the second and third heat exchangers.

The first heat exchanger may be a water-cooled condenser, the second heat exchanger may be a water-cooled evaporator, and the third heat exchanger may be a chiller.

The second fluid, which exchanges heat in the water-cooled condenser, may perform indoor heating of a vehicle, the second fluid, which exchanges heat in the water-cooled evaporator, may perform indoor cooling of the vehicle, and the second fluid, which exchanges heat in the chiller, may cool a battery.

### Advantageous Effects

According to an embodiment of the present invention, cost reduction, weight reduction, and increased workability can be achieved using a manifold plate which performs the functions of piping, fittings, and a housing.

Also, according to an embodiment of the present invention, thermal interference between refrigerants can be minimized and heat pump performance can be increased through the arrangements of the fluid flow paths of the heat exchanger and the manifold plate.

### DESCRIPTION OF DRAWINGS

FIG. 1 is a perspective view illustrating a manifold fluid module according to an embodiment of the present invention.

FIG. 2 is a perspective view illustrating a manifold plate of the manifold fluid module according to the embodiment of the present invention.

FIG. 3 is a view illustrating a plan view of the manifold fluid module according to the embodiment of the present invention.

FIG. 4 is a view illustrating an overall flow of a first fluid of the manifold fluid module according to the embodiment of the present invention.

FIG. 5 is a view illustrating a first heat exchanger of the manifold fluid module according to the embodiment of the present invention.

FIG. 6 is a view illustrating a second heat exchanger of the manifold fluid module according to the embodiment of the present invention.

FIG. 7 is a view illustrating a third heat exchanger of the manifold fluid module according to the embodiment of the present invention.

FIG. 8 is a view illustrating a flow of the first fluid which flows in and out in the manifold fluid module according to the embodiment of the present invention.

FIG. 9 is a view illustrating that the second heat exchanger and the third heat exchanger are coupled to the manifold plate of the manifold fluid module according to the embodiment of the present invention.

FIG. 10 is a view illustrating a front side of the second heat exchanger of the manifold fluid module according to the embodiment of the present invention.

FIG. 11 is a view illustrating a front side of the third heat exchanger of the manifold fluid module according to the embodiment of the present invention.

### MODES OF THE INVENTION

The present invention may undergo various modifications and have several embodiments. Specific embodiments are illustrated in the drawings and described in detail. However, this is not intended to limit the invention to specific forms, and it should be understood to include all modifications, equivalents, and alternatives that fall within the spirit and scope of the invention as defined by the claims. In describing the present invention, detailed descriptions of related known technologies are omitted when it is determined that they may obscure the essence of the invention.

The terms “first,” “second,” and so on may be used to describe various components, but these components should not be limited by these terms. These terms are only used to distinguish one component from another.

The terminology used in this application is intended to describe particular embodiments only, and is not intended to limit the scope of the invention. Singular expressions include plural expressions unless the context clearly dictates otherwise. In this application, terms such as “include” and “have” indicate the presence of stated features, numbers, steps, operations, components, parts, or combinations thereof, but do not preclude the presence or addition of one or more other features, numbers, steps, operations, components, parts, or combinations thereof.

Furthermore, throughout this specification, when an element is referred to as being “connected to” another element, it is not limited to the two elements being directly connected. It can also include indirect connections through one or more other elements, both physically and electrically. Additionally, it may refer to elements that are integrally connected, even if they are referred to by different names based on their position or function.

Hereinafter, an embodiment of the manifold fluid module according to the present invention will be described in detail with reference to the accompanying drawings. In the description with reference to the attached drawings, the same or corresponding components are assigned the same reference numerals, and redundant explanations thereof will be omitted.

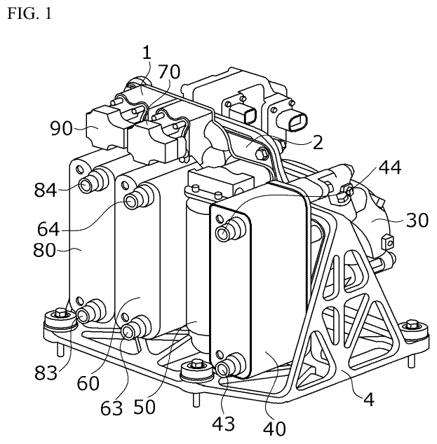

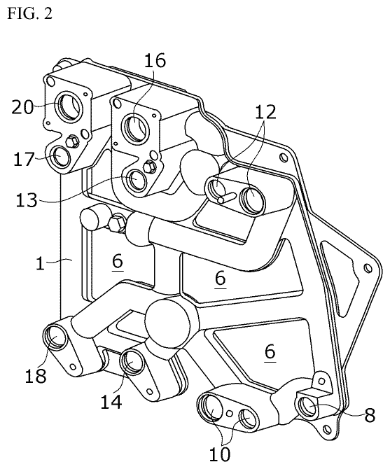

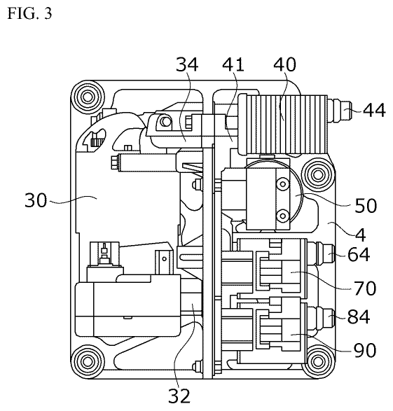

FIG. 1 is a perspective view illustrating a manifold fluid module according to an embodiment of the present invention, FIG. 2 is a perspective view illustrating a manifold plate of the manifold fluid module according to the embodiment of the present invention, and FIG. 3 is a view illustrating a plan view of the manifold fluid module according to the embodiment of the present invention.

As shown in the drawings, the manifold fluid module according to the embodiment of the present invention may include a manifold plate 1 having a fluid flow path formed therein, a compressor 30 coupled to the manifold plate 1, a first heat exchanger 40 which is coupled to the manifold plate 1, into which a first fluid, which flows out of the compressor 30, directly flows, and which exchanges heat between the first fluid and a second fluid, and a second heat exchanger 60 which is coupled to the manifold plate 1 and exchanges heat between the second fluid and the first fluid flowing out of the first heat exchanger.

A bottom plate 2 may be coupled to one surface of the manifold plate 1 to cover a flow path and may be manufactured in a coupling manner that uses brazing, structural adhesives, gaskets, and the like. Also, the material of the manifold plate 1, such as aluminum, thermo-plastic, stainless steel, or the like, may vary according to its purposes and functions. The bottom plate 2 may be installed in a mounting frame 4 which has a structure for being mounted in a vehicle.

The manifold plate 1 is formed so that a flow path is approximately fitted inside and has a plate shape with a predetermined thickness. The manifold plate 1 is modularized by coupling the first heat exchanger 40, the second heat exchanger 60, a third heat exchanger 80, which are heat exchange devices of a heat pump system, an accumulator 50, and expansion valves 70 and 90, thereby reducing both product manufacturing man-hours and vehicle assembly line man-hours. Also, the manifold plate 1 simultaneously performs functions of piping, fittings, and a housing to reduce costs and increase workability.

The manifold plate 1 may have an opening 6 formed to be open to the front and rear. The opening 6 is a portion formed to maximize separation between a high temperature area and a low temperature area within the flow paths of the manifold plate 1 and serves to prevent interference with the fluid port of the heat exchanger. The opening 6 may be formed adjacent to a flow path of a first fluid, which flows into the compressor 30, to prevent thermal interference.

Referring to FIG. 2, a fluid flow path may be formed on a rear surface of the manifold plate 1 to guide movement of the fluid during heat exchange, expansion, inflow, and outflow of the fluid. Also, various fluid ports for inflow and outflow of the fluid may be provided on a rear surface of the manifold plate 1. In the embodiment, the fluid ports may include a first heat exchanger outlet port 8 through which the first fluid flows out of the first heat exchanger 40, an accumulator inlet port 10 and an accumulator outlet port 12 through which the first fluid flows from and to the accumulator 50, a second heat exchanger inlet port 13 and a second heat exchanger outlet port 14 through which the first fluid flows to and from the second heat exchanger 60, and a third heat exchanger inlet port 17 and a third heat exchanger outlet port 18 through which the first fluid flows from and to the third heat exchanger 80. Also, a first expansion valve port 16 and a second expansion valve port 20 may be provided on a rear surface of the manifold plate 1, wherein the first expansion valve port 16 allows the first fluid to flow in and out using the first expansion valve 70, and the second expansion valve port 20 allows the first fluid to flow in and out using the second expansion valve 90.

Referring to FIGS. 1 and 3, the compressor 30 may be coupled to one surface of the manifold plate 1, that is, the rear surface. The compressor 30 serves to compress the first fluid at a high temperature and a high pressure, and to move the first fluid to the first heat exchanger 40. The first heat exchanger 40, the second heat exchanger 60, and the third heat exchanger 80, which are heat exchange devices, are coupled to one surface of the manifold plate 1, that is, the front surface of the manifold plate 1. The first fluid and the second fluid may exchange heat while passing through the first heat exchanger 40, the second heat exchanger 60, and the third heat exchanger 80.

In the exemplary embodiment, a water-cooled condenser may be used as the first heat exchanger 40, a water-cooled evaporator may be used as the second heat exchanger 60, and a chiller may be the third heat exchanger 80. The water-cooled condenser serves to condense a high-temperature and high-pressure gaseous fluid (refrigerant), which flows out of a compressor or an internal condenser, into a high-pressure liquid by exchanging heat between the gaseous fluid and an external cooling source. The water-cooled evaporator serves to evaporate and cool the second fluid by exchanging heat between an expanded first fluid (refrigerant) and a second fluid (cooling water). The second fluid, which exchanges heat in the water-cooled condenser, may perform interior heating in the vehicle, and the second fluid, which exchanges heat in the water-cooled evaporator, may perform interior heating in the vehicle. The chiller is a device that exchanges heat between the supplied low-temperature and low-pressure first fluid and the second fluid (refrigerant) moving in a cooling water circulation line (not shown). The chiller may exchange heat between the cold second fluid, which exchanges heat in the chiller, and a battery by circulating the second fluid in the cooling water circulation line.

Meanwhile, the first fluid and the second fluid may be applied as the refrigerant, the cooling water, and the like. The first fluid may be applied as the refrigerant, and the second fluid may be applied as the cooling water.

The first heat exchanger 40 is directly connected to the compressor 30 so that the fluid moves. To explain more specifically, a first fluid inlet port 41 into which the first fluid flows from the first heat exchanger 40 is directly connected to a port into which the first fluid flows from the compressor 30, and the first fluid may directly flow without passing through a flow path on the manifold plate 1. In other words, the first fluid may move through a directly connected flow path without passing through the manifold plate 1 in a process in which the first fluid moves from the compressor 30 to the first heat exchanger 40.

When the fluid does not move through a flow path on a separate manifold plate 1 from the compressor 30 in this way, the high pressure and high temperature first fluid (at the highest temperature and pressure in the heat pump system) compressed in the compressor 30 can be fundamentally prevented from transferring heat through the manifold plate 1, thereby improving the performance of the heat pump system. As shown in FIG. 1, the compressor 30 and the first heat exchanger 40 are coupled to the manifold plate 1, but are partially coupled so that the first fluid directly flows without connection through the manifold plate 1.

To explain more specifically, the compressor 30 includes a first fluid inlet port 32 and a first fluid outlet port 34, and the first heat exchanger 40 includes a first fluid inlet port 41 and a first fluid outlet port 42. Any one of the first fluid inlet port 32 or the first fluid outlet port 34 of the compressor 30 may be directly connected to and communicate with any one of the first fluid inlet port 41 or the first fluid outlet port 42 of the first heat exchanger 40.

In the drawings, the first fluid outlet port 34 of the compressor 30 is directly connected to and communicates with the first fluid inlet port 32 of the first heat exchanger 40. The first fluid inlet port 32 of the compressor 30 is coupled to one surface of the manifold plate 1, and the first fluid outlet port 42 of the first heat exchanger 40 may be coupled to the other surface of the manifold plate 1.

The first heat exchanger 40 is disposed on one side of the manifold plate 1, that is, a left end or right end, and the accumulator 50, the second heat exchanger 60, and the third heat exchanger 80 may be sequentially disposed on the other side. Components required for fluid flow are sequentially disposed to be integrated and modularized in a limited space of the manifold plate 1.

Additionally, a first expansion valve 70 and a second expansion valve 90 are disposed on an upper portion of the second heat exchanger 60 and an upper portion of the third heat exchanger 80. The first expansion valve 70 and the second expansion valve 90 expand the first fluid introduced into the second heat exchanger 60 and the third heat exchanger 80.

The accumulator 50 divides the first fluid, which passes through the second heat exchanger 60, into a gaseous fluid and a liquid fluid. In the embodiment, a separate heat exchanger is provided in the accumulator 50 so that the first fluid, which has passed through the first heat exchanger 40, flows into the heat exchanger and exchanges heat and then flows into the second heat exchanger 60 and the third heat exchanger 80.

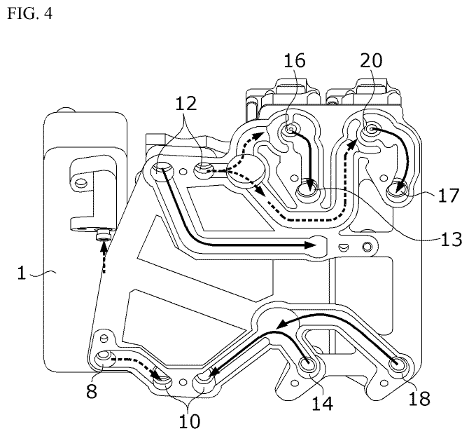

FIG. 4 is a view illustrating the overall flow of the first fluid in a manifold fluid module according to the embodiment of the present invention. For reference, dotted arrows indicate the flow of a high-temperature and high-pressure first fluid, while solid arrows indicate the flow of a low-temperature and low-pressure first fluid.

Referring to this, the first fluid, which is compressed by the compressor 30 to a high temperature and high pressure, flows into the first heat exchanger 40. The first fluid, which exchanges heat with the second fluid in the first heat exchanger 40, flows out through the first heat exchanger outlet port 8. Additionally, the first fluid flows into the accumulator 50 through the accumulator inlet port 10 and exchanges heat in the internal heat exchanger. Next, the first fluid flows into the first expansion valve 70 and the second expansion valve 90 through the first expansion valve port 16 and the second expansion valve port 20.

The first fluid introduced into the first expansion valve 70 and the second expansion valve 90 expands and flows into the second heat exchanger 60 and the third heat exchanger 80 through the second heat exchanger inlet port 13 and the third heat exchanger inlet port 17. The first fluid, which exchanges heat with the second fluid in the second heat exchanger 60 and the third heat exchanger 80, flows out through the second heat exchanger outlet port 14 and the third heat exchanger outlet port 18 and flows into the accumulator 50 through the accumulator inlet port 10. The first fluid divided into the gaseous fluid and the liquid fluid in the accumulator 50 flows back into the compressor 30 and may circulate repeatedly through the same process described above.

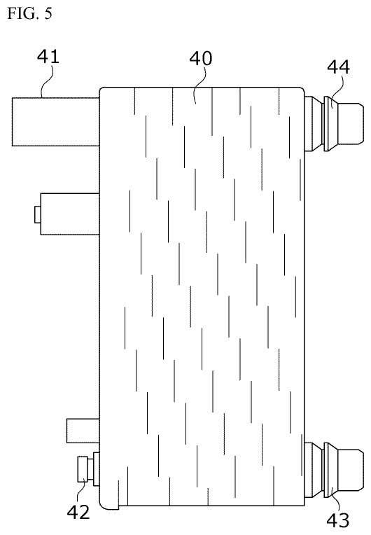

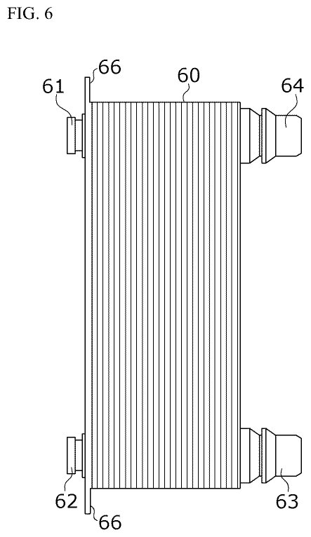

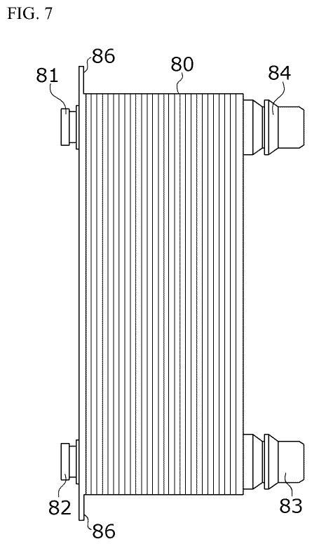

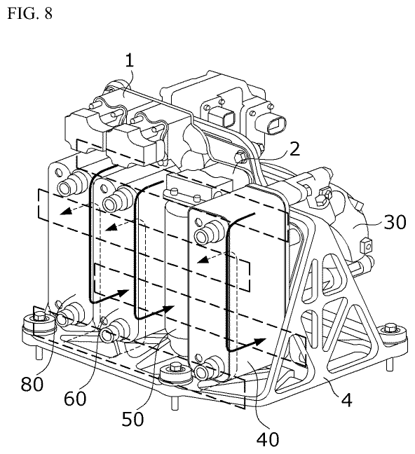

FIG. 5 is a view illustrating a first heat exchanger of the manifold fluid module according to the embodiment of the present invention, FIG. 6 is a view illustrating a second heat exchanger of the manifold fluid module according to the embodiment of the present invention, FIG. 7 is a view illustrating a third heat exchanger of the manifold fluid module according to the embodiment of the present invention, and FIG. 8 is a view illustrating a flow of the first fluid which flows in and out in the manifold fluid module according to the embodiment of the present invention.

Referring to FIG. 5, the first fluid inlet port 41 and the first fluid outlet port 42 for inflow and outflow of the first fluid are provided on one surface of the first heat exchanger 40, that is, a rear surface. The first fluid inlet port 41 and the first fluid outlet port 42 may be provided on one surface coupled to the manifold plate 1. This is to minimize thermal interference between the high-temperature and low-temperature areas of the first fluid by eliminating separate piping for the flow of the first fluid and minimizing a flow section of the first fluid circulating through the manifold plate 1. Additionally, the first fluid inlet port 41 is provided at an upper side and the first fluid outlet port 42 is provided at a lower side, thereby moving the first fluid in the direction of gravity.

The second fluid inlet port 43 and the second fluid outlet port 44 for inflow and outflow of the second fluid are provided on the other surface of the first heat exchanger 40, that is, a front surface. In the embodiment, since the second fluid inlet port 43 is provided on a lower portion of the first heat exchanger 40 and the second fluid outlet port 44 is provided on an upper portion of the first heat exchanger 40, the second fluid moves from the lower portion to the upper portion. Since the second fluid flows while filling a flow cross-sectional area in this way when the second fluid moves from the lower portion to the upper portion, the flow efficiency of the second fluid can be improved.

As described above, in the embodiment, by providing a port for the inflow and outflow of the first fluid on one surface of the first heat exchanger 40 and a port for the inflow and outflow of the second fluid on the other surface, heat exchange between the first fluid and the second fluid can be easily achieved, and the assembly efficiency for coupling with the manifold plate 1 can be improved.

Referring to FIGS. 6 and 7, first fluid inlet ports 61 and 81 and first fluid outlet ports 62 and 82 for inflow and outflow of the first fluid are provided on one surface of each of the second heat exchanger 60 and the third heat exchanger 80, that is, rear surfaces. The first fluid inlet ports 61 and 81 and the first fluid outlet ports 62 and 82 may be provided on one surface coupled to the manifold plate 1. This is to minimize thermal interference between a high temperature area and a low temperature area of the first fluid by eliminating separate piping for flow of the first fluid and minimizing a flow section of the first fluid circulating in the manifold plate 1. Additionally, since the first fluid inlet ports 61 and 81 are provided at an upper side and the first fluid outlet ports 62 and 82 are provided at a lower side, the first fluid may move in the direction of gravity.

The second fluid inlet ports 63 and 83 and the second fluid outlet ports 64 and 84 for inflow and outflow of the second fluid are provided on the other surfaces of each of the second and third heat exchangers 60 and 80, that is, front surfaces. In the embodiment, since the second fluid inlet ports 63 and 83 are provided on lower portions of the second and third heat exchangers 60 and 80 and the second fluid outlet ports 64 and 84 are provided on upper portions of the second and third heat exchangers 60 and 80, the second fluid moves from the lower portion to the upper portion. Since the second fluid flows while filling a flow cross-sectional area in this way when the second fluid moves from the lower portion to the upper portion, the flow efficiency of the second fluid can be improved.

As described above, in the embodiment, by providing ports for inflow and outflow of the first fluid on one surface of each of the second heat exchanger 60 and the third heat exchanger 80 and providing ports for inflow and outflow of the second fluid on the other surfaces, heat exchange between the first fluid and the second fluid can be easily achieved, and assembly efficiency for coupling with the manifold plate 1 can be improved.

Referring to FIG. 8, dotted portions in FIG. 8 indicate portions at which the first fluid and the second fluid flow in and out, solid arrows indicate the movement of the first fluid, and dashed arrows indicate the movement of the second fluid. In this way, since the first fluid moves through an inner portion of the heat exchanger, which is directly connected to the manifold plate 1, and the second fluid moves through an outer portion of the heat exchanger, thermal interference with the second fluid directly transferred from the manifold plate 1 can be minimized.

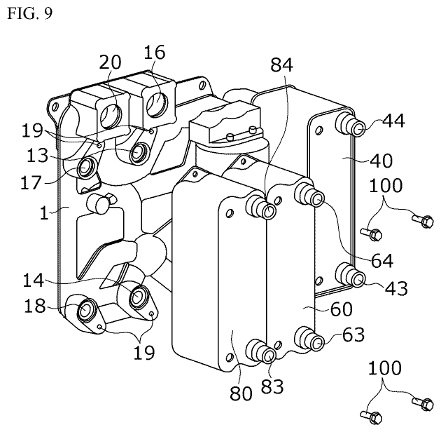

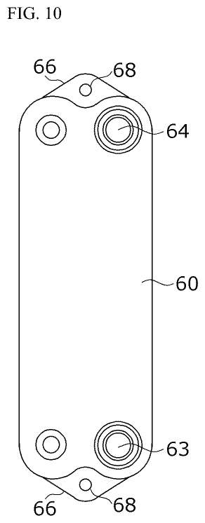

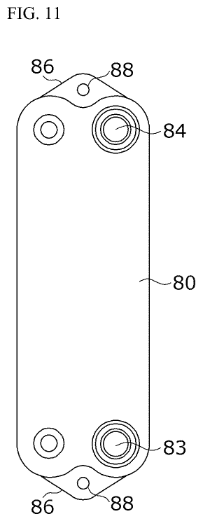

FIG. 9 is a view illustrating that the second heat exchanger and the third heat exchanger are coupled to the manifold plate of the manifold fluid module according to the embodiment of the present invention, FIG. 10 is a view illustrating a front side of the second heat exchanger of the manifold fluid module according to the embodiment of the present invention, and FIG. 11 is a view illustrating a front side of the third heat exchanger of the manifold fluid module according to the embodiment of the present invention.

Referring to the drawings, fastening grooves 19 for coupling with the second heat exchanger 60 and the third heat exchanger 80 are formed on the manifold plate 1. The fastening grooves 19 may be formed at locations corresponding to an upper portion and a lower portion of the second heat exchanger 60 and the third heat exchanger 80.

Moreover, fastening parts 66 and 86 are formed to extend from an upper portion and a lower portion of the second heat exchanger 60 and the third heat exchanger 80, and fastening holes 68 and 88 are formed to pass through the fastening parts 66 and 86. Fastening bolts 100 pass through the fastening holes 68 and 88 and are fastened to the fastening grooves 19, and the second heat exchanger 60 and the third heat exchanger 80 are coupled to the manifold plate 1. In this manner, the assembly efficiency of the second heat exchanger 60 and the third heat exchanger 80 can be improved through the above-described fastening structure in the embodiment. Meanwhile, although the second heat exchanger 60 and the third heat exchanger 80 have been described as examples, the present invention is not limited to these. The above-described fastening structure can be applied to any components coupled to the manifold plate 1, including the first heat exchanger 40, the accumulator 50, and the like.

While the present invention has been described above with reference to specific exemplary embodiments, it will be understood by those skilled in the art that various modifications and changes can be made to the present invention without departing from the spirit and scope thereof as set forth in the following claims.

### DESCRIPTIONS OF SYMBOLS

1: manifold plate 2: bottom plate
4: mounting frame 6: opening
8: first heat exchanger outlet port 10: accumulator inlet port
12: accumulator outlet port 13: second heat exchanger inlet port
14: second heat exchanger outlet port 16: first expansion valve port
17: third heat exchanger inlet port 18: third heat exchanger outlet port
20: second expansion valve port 30: compressor
40: first heat exchanger 41: first fluid inlet port
42: first fluid outlet port 43: second fluid inlet port
44: second fluid outlet port 50: accumulator
60: second heat exchanger 61: first fluid inlet port
62: first fluid outlet port 63: second fluid inlet port
64: second fluid outlet port 66: fastening part
68: fastening hole 70: first expansion valve
80: third heat exchanger 81: first fluid inlet port
82: first fluid outlet port 83: second fluid inlet port
84: second fluid outlet port 86: fastening part
88: fastening hole 90: second expansion valve
100: fastening bolt

1. A manifold fluid module comprising:
a manifold plate in which a fluid flow path is formed;
a compressor coupled to the manifold plate; and
a first heat exchanger which is coupled to the manifold plate, is connected to directly receive a first fluid flowing out of the compressor, and exchanges heat between the first fluid and a second fluid,
wherein the compressor is coupled to one surface of the manifold plate, and the first heat exchanger is coupled to the other surface of the manifold plate,
the compressor has a first fluid inlet port and a first fluid outlet port,
the first heat exchanger has a first fluid inlet port and a first fluid outlet port, and
any one of the first fluid inlet port or the first fluid outlet port of the compressor is directly connected to and communicates with any one of the first fluid inlet port or the first fluid outlet port of the first heat exchanger.

2. The manifold fluid module of claim 1, wherein the first fluid outlet port of the compressor is directly connected to and communicates with the first fluid inlet port of the first heat exchanger.

3. The manifold fluid module of claim 1, wherein the first inlet port of the compressor is coupled to one surface of the manifold plate, and the first fluid outlet port of the first heat exchanger is coupled to the other surface of the manifold plate.

4. The manifold fluid module of claim 1, further comprising a second heat exchanger coupled to the manifold plate and exchanging heat between the first fluid, which flows out of the first heat exchanger, and the second fluid.

5. The manifold fluid module of claim 4, wherein the exchanging of the heat is performed by allowing the first fluid to flow into an upper portion and move to a lower portion in the first heat exchanger and allowing the first fluid to flow into a lower portion and move to an upper portion in the second heat exchanger.

6. The manifold fluid module of claim 4, wherein the first fluid inlet port and the first fluid outlet port for inflow and outflow of the first fluid are provided on one surface of each of the first heat exchanger and the second heat exchanger, and the second fluid inlet port and the second fluid outlet port for inflow and outflow of the second fluid are provided on the other surface of each of the first heat exchanger and the second heat exchanger.

7. The manifold fluid module of claim 6, wherein the first fluid inlet port and the first outlet port are directly connected to the fluid flow path of the manifold plate, and the second fluid inlet port and the second fluid outlet port are provided outside the first heat exchanger and the second heat exchanger.

8. The manifold fluid module of claim 6, wherein the first fluid inlet ports are disposed on upper portions of the first heat exchanger and the second heat exchanger, and the first fluid outlet ports are disposed on lower portions of the first heat exchanger and the second heat exchanger.

9. The manifold fluid module of claim 6, wherein the second fluid inlet ports are disposed on lower portions of the first heat exchanger and the second heat exchanger, and the second fluid outlet ports are disposed on upper portions of the first heat exchanger and the second heat exchanger.

10. The manifold fluid module of claim 4, wherein fastening parts for coupling with the manifold plate are formed to extend from an upper portion and a lower portion of the second heat exchanger.

11. The manifold fluid module of claim 1, wherein at least one opening is formed in the manifold plate to avoid thermal interference between a high temperature first fluid and a low temperature first fluid.

12. The manifold fluid module of claim 11, wherein the opening is formed adjacent to a flow path of the first fluid flowing into the compressor.

13. The manifold fluid module of claim 4, wherein a third heat exchanger and an accumulator are coupled to the manifold plate,
wherein the third heat exchanger evaporates the first fluid, which flows out of the first heat exchanger, by exchanging heat between the first fluid and the second fluid, and
the accumulator divides the first fluid, which passes through the second heat exchanger, into a gaseous fluid and a liquid fluid.

14. The manifold fluid module of claim 13, wherein the first heat exchanger is disposed on one side of the manifold plate, the second heat exchanger and the third heat exchanger are disposed on the other side, and the accumulator is disposed between the first heat exchanger and the second and third heat exchangers.

15. The manifold fluid module of claim 13, wherein the first heat exchanger is a water-cooled condenser, the second heat exchanger is a water-cooled evaporator, and the third heat exchanger is a chiller.

16. The manifold fluid module of claim 15, wherein the second fluid, which exchanges heat in the water-cooled condenser, performs indoor heating of a vehicle, the second fluid, which exchanges heat in the water-cooled evaporator, performs indoor cooling of the vehicle, and the second fluid, which exchanges heat in the chiller, cools a battery.
